(19) United States
(12) Patent Application Publication
(10) Pub. No.: US 2010/0224033 A1
(43) Pub. Date: Sep. 9, 2010

(54) HANDHELD POWER TOOL

(76) Inventors: Sim Teik Yeoh, Butterworth (MY); Manfred Lutz, Filderstadt (DE)

Correspondence Address: MICHAEL J. STRIKER, 103 EAST NECK ROAD, HUNTINGTON, NY, 11743, US

(21) Appl. No.: 12/095,602

(22) PCT Filed: Jul. 31, 2007
(86) PCT No.: PCT/EP07/57894

§ 371 Date: May 30, 2008

(30) Foreign Application Priority Data
Sep. 27, 2006 (DE) 102006045842.7

(51) Int. Cl. B25B 21/02; B25D 16/00; B25F 5/02

(52) U.S. Cl. 81/57.11; 173/216; 173/217

(57) ABSTRACT

The invention relates to a hand-held machine tool, particularly a rotary percussion drill, comprising an electric motor (10) for driving a drive shaft (12), a multistage gear system (30) for coupling the drive shaft (12) to an output shaft (51), and a mechanical impact unit (50) for percussively driving an inserted tool in a tool holder (62).

### PRIOR ART

The invention relates to a handheld power tool, in particular a rotary percussion screwdriver, as generically defined by the preamble to claim 1.

Rotary percussion screwdrivers are known that to step down the high motor rpm to a lower rpm have a one-stage gear, such as a planetary gear. Particularly at rotary speeds of 2000-3000 rpm, a gear with a comparatively large circumference is necessary, to attain the desired rotary speed conversion. However, since a compact construction is desired for handheld power tools, such as rotary percussion screwdrivers and others, a gear that requires a relatively large amount of installation space is not suitable. In addition, there is a need for great flexibility in adapting the rotary speed and torque of the driven side.

### DISCLOSURE OF THE INVENTION

The handheld power tool according to the invention, in particular a rotary percussion screwdriver, has a multi-speed gear, such as a two-speed gear. As a result, the gear can be made smaller in its diameter, so that less installation space is required for the gear. Moreover, a multi-speed gear is simple to design for different demands in terms of rotary speed and torque. The handheld power tool of the invention furthermore has the advantage of low energy consumption.

The gear is preferably a planetary gear, which because of its compact construction is can be integrated especially readily with the handheld power tool and makes a compact construction of the overall handheld power tool possible. The multi-speed gear, in particular the planetary gear, is preferably a one-speed gear.

The handheld power tool of the invention includes an electric motor for driving a drive shaft. The drive shaft is coupled to a driven shaft via a multi-speed gear, such as a two-speed gear. A mechanical percussion mechanism, in particular a mechanical rotary percussion mechanism, such as a V-groove rotary percussion mechanism, assures a hammering drive of a tool insert. The function and construction of a mechanical percussion mechanism, especially a rotary percussion mechanism, are well known in the prior art. The driven shaft drives a tool receptacle, in which a tool insert, such as a screwdriver bit, is located.

The driven shaft is supported in at least two bearings. At least one bearing is located on the end of the driven shaft toward the gear. This bearing will hereinafter be called the gear-end bearing. Preferably, the gear-end bearing is connected downstream of the gear. This means that the gear-end bearing is located after the gear in terms of the working direction. As a result, the driven shaft does not pass through the multi-speed gear.

If the multi-speed gear is a multi-speed planetary gear, then in a preferred embodiment, the driven shaft is embodied on its gear end as a planet carrier. To that end, the driven shaft on its gear end has pins, for instance, on which the planet wheels are mounted.

In a further preferred embodiment, at least for the multi-speed gear, the gear-end bearing, and part of the driven shaft, a separate housing is provided. The separate housing for the gear, the gear-end bearing, and at least part of the driven shaft will hereinafter be called the gearbox. The housing with the gear, the gear-end bearing, and part of the driven shaft thus forms a module, which can be built into the housing of the handheld power tool. On being built into the housing of the handheld power tool, the gear end of the module is connected to the drive shaft of the electric motor. The free end of the driven shaft, which protrudes from the housing and forms the end of the module diametrically opposite the gear end, is connected to the mechanical percussion mechanism. The result is a modular construction comprising the electric motor, the gearbox, the percussion mechanism, and the tool receptacle. This modular construction facilitates the assembly of the handheld power tool considerably. The gearbox is preferably of plastic, making the additional weight of the gearbox insignificant.

A separate gearbox furthermore has the advantage that the components of the gear and the bearing that are impacted by lubricating grease, oil, or the like are located in an essentially closed housing, so that other components of the handheld power tool, such as electronic components, do not become soiled by the lubricating grease, oil, or the like. The gearbox is therefore preferably provided, on its gear end, or in other words the end toward the electric motor, with a covering element, preferably also of plastic. The covering element may be a lid, cap, or the like. It has a central opening for receiving the drive shaft of the electric motor. The covering element in particular prevents lubricating grease, oil, or the like from escaping and prevents of dust particles or other dirt particles from penetrating the gear end of the gearbox. The covering element can additionally serve to receive and fix the electric motor, so that the gearbox with the electric motor forms a structural unit.

The handheld power tool of the invention is in particular a rotary percussion screwdriver.

The invention is described in further detail below in conjunction with the drawings.

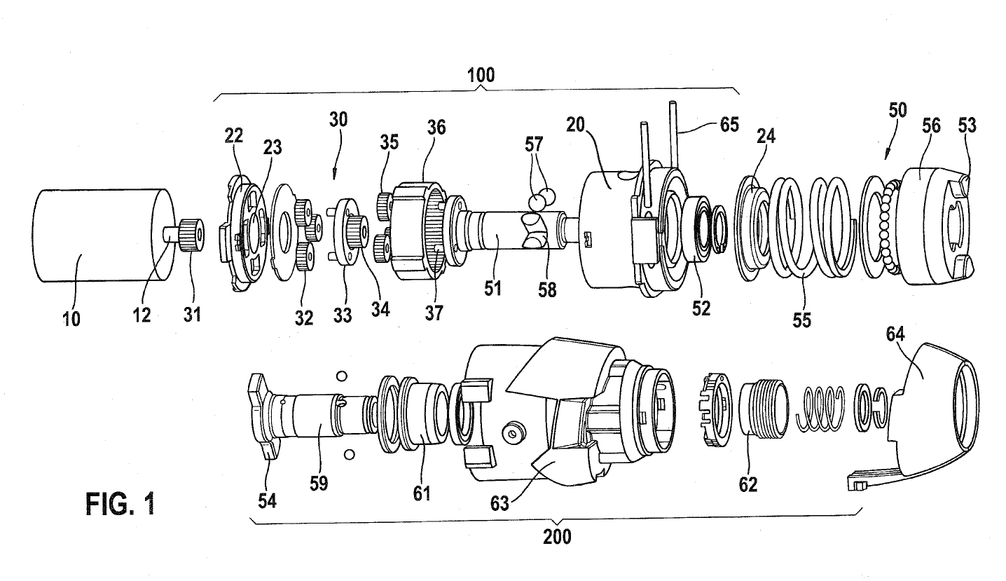

FIG. 1 shows an embodiment of the handheld power tool of the invention with a two-speed planetary gear and a percussion mechanism, in an exploded view; and

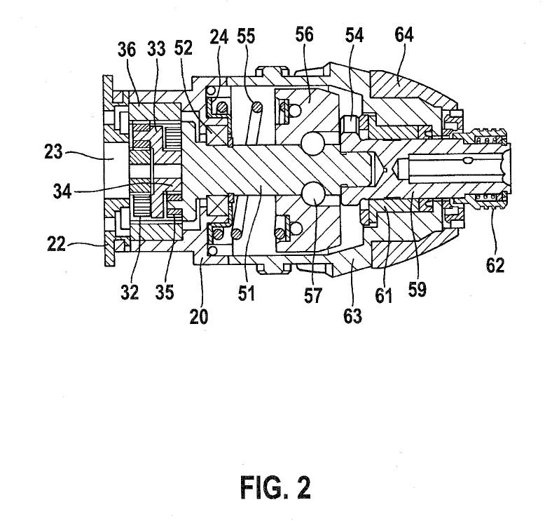

FIG. 2 shows a cross section through the two-speed planetary gear with the percussion mechanism of FIG. 1.

In the exploded view of FIG. 1, the drive train of one embodiment of a handheld power tool of the invention is shown, which includes the components of an electric motor, a two-stage, one-speed gear, a mechanical percussion mechanism, and a tool receptacle. The embodiment shown involves the mechanical components of a rotary percussion screwdriver. Below, only the components essential to the invention will be described in detail.

An electric motor 10 includes a drive shaft 12, on which a gear wheel, as a drive pinion 31, is located in a manner fixed against relative rotation. The drive pinion 31 forms part of a two-stage planetary gear 30 and drives planet wheels 32 of the first gear stage. The planet wheels 31 roll inside a ring gear 36. As a result, a first planet carrier 33 is rotated, which in turn, via toothing 34, drives further planet wheels 35 of the second gear stage. The planet wheels 35 roll inside the ring gear 36 and drive a second planet carrier 37. The second planet carrier 37 is connected to the driven shaft 51 in a manner fixed against relative rotation. For that purpose, in FIG. 1, the planet carrier 37 is embodied in the form of pins that are integral with the driven shaft 51. The driven shaft 51 is supported on its gear end in a bearing 52, preferably a roller bearing, in particular a deep-groove ball bearing. The two-stage planetary gear 30, the bearing 52, and part of the driven shaft 51 are received in a separate housing 20 made of plastic. On the gear end, the housing 20 is provided with a cap, also of plastic, as a covering element 22. The covering element 22 has a central opening 23 for receiving the drive shaft 12. On the diametrically opposite end, the bearing end, of the housing 20, the driven shaft 51 protrudes from the housing 20.

The two-stage planetary gear 50, the gear-end bearing 52, and part of the driven shaft 51 in the housing 20, together with the covering element 22, form a first module 100. The module is connected on the gear end to the drive pinion 31 on the drive shaft 12 of the electric motor 10. On the bearing end, the module 100 is connected to the percussion mechanism 50, via the driven shaft 51 that protrudes from the housing 20.

The driven shaft 51 together with the bearing 52 forms part of a mechanical percussion mechanism 50, which in the embodiment shown is a V-groove rotary percussion mechanism. The percussion mechanism 50 includes a compression spring 55, a rotary percussion weight 56 with drive cams 53, slaving balls 57 in a V-shaped groove 58, and driven cams 54 that are embodied integrally with an extension piece 59 of the driven shaft 51. The extension piece 59 is supported in a second bearing 61. A shim 24 serves to receive and fix the compression spring 55 as well as to protect the housing 20 against heating and wear from the friction of the spring 55. The mode of operation of a V-groove rotary percussion mechanism will not be addressed in detail here, since it is well known to one skilled in the art. For receiving a tool insert (not shown), the extension piece 59 of the driven shaft 51 is connected to a tool receptacle 62. The percussion mechanism with the extension piece 59 of the driven shaft 51 is received in a housing part 63, preferably of metal. A housing baffle 64 of an elastic plastic covers at least part of the housing part 63. The module 100 is connected to the housing part 63 via pins 65. As a result, the percussion mechanism 50 is also received in a closed housing, so that no lubricating grease, oil, or the like can escape and no dirt particles can enter.

The housing part 63 together with the driven shaft 59 and the tool receptacle 62 forms a second module 200. The percussion mechanism 50 is located as a unit between the first module 100 and the second module 200. This makes a modular construction of the entire drive train of the handheld power tool possible, with the advantage that individual modules are easily replaceable.

In FIG. 2, the components of the rotary percussion screwdriver of FIG. 1 are shown in cross section. It can be seen here that the driven shaft 51 does not pass through the two-stage planetary gear 50, but instead, upstream in terms of the working direction of the planetary gear 50, is supported in a bearing 52; in other words, the bearing 52 is downstream of the planetary gear 50.

1. A handheld power tool, in particular a rotary percussion screwdriver, including an electric motor (10) for driving a drive shaft (12), a gear (30) for coupling the drive shaft (12) to a driven shaft (51), and a mechanical percussion mechanism (50) for a hammering drive of a tool insert in a tool receptacle (62), characterized in that the gear (30) is a multi-speed gear.

2. The handheld power tool as defined by claim 1, characterized in that the gear (30) is a one-speed gear.

3. The handheld power tool as defined by claim 1, characterized in that the gear (30) is a planetary gear.

4. The handheld power tool as defined by claim 1, characterized in that at least one gear-end bearing (52) for supporting the driven shaft (51) is provided, which is connected downstream of the gear (30).

5. The handheld power tool as defined by claim 3, characterized in that the driven shaft (51) is embodied on its gear end as a planet carrier (37).

6. The handheld power tool as defined by claim 4, characterized in that a housing (20), in particular of plastic, is provided, which receives at least the gear (30), the gear-end bearing (52), and part of the driven shaft (51), so that the housing (20), with the gear (30), the gear-end bearing (52), and part of the driven shaft (51), forms a first module (100).

7. The handheld power tool as defined by claim 6, characterized in that the housing (20) is provided, on its side toward the electric motor (10), with a covering element (22).

8. The handheld power tool as defined by claim 1, characterized in that a housing part (63) is provided for receiving the percussion mechanism (50), the tool receptacle (62), and at least part of the driven shaft (51).

9. The handheld power tool as defined by claim 8, characterized in that the housing part (63) is connectable to the housing (20).

10. The handheld power tool as defined by claim 8, characterized in that the housing part (63) together with the tool receptacle (62) and at least part of the driven shaft (51) forms a second module (200).

11. The handheld power tool as defined by claim 10, characterized in that the percussion mechanism (50) is located between the first module (100) and the second module (200).
